(19) United States
(12) Patent Application Publication
(10) Pub. No.: US 2005/0076769 A1
(43) Pub. Date: Apr. 14, 2005

(54) Valve device for musical instrument and metallic wind instrument comprising the same

(76) Inventors: Walter Singer, Reichenau/Rax (AT); Lars Michael Stransky, Grub (AT); Haruo Kimura, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/479,160

(22) PCT Filed: May 30, 2001
(86) PCT No.: PCT/JP01/04569

(51) Int. Cl. G10D 7/10

(52) U.S. Cl. 84/387 R

(57) ABSTRACT

Since the casing newly developed for the entire valve block of a brasswind instrument is made of resin, the dimensions of all inner movable parts can be increased without increasing substantially the weight of the entire valve block. This additional degree of freedom in design allows for planning and manufacturing of both inner sound channels and switching channels of movable inner parts so that they have a perfectly circular profile and a smooth inner surface. Therefore, by providing an ideal sound channel without increasing the overall weight of the valve block, a considerable improvement in the sound quality of an instrument can be achieved.

### FIELD OF THE INVENTION

This invention describes and documents valve block devices and brasswind instruments and other instruments being equipped with these types of valve block devices, which can change the pitch and tone by the switching of valve slides.

### BACKGROUND ART

Traditional instruments consist of a set of metal pipes, usually of brass, which are either connected to each other or connected to valves. In the case of a horn, the valve used to switch the bell pipe consists of a cylindrical enclosure, the valve casing and an internal rotor, the switcher, all forming an integrated unit. When several such valves are connected with each other by short pipes, a valve block device is formed. That in turn can be connected with short pipes, the valve slides, to the instrument and, one has a brasswind instrument with a valve block device. When such a valve block device is connected through valve slides to the sound tube, it contains, in addition, a link mechanism consisting of push and pull levers that permit adjustment of the pitch of sound by turning the switcher that is fixed on an axle inside the valve itself.

It is a common belief, that, in order to minimize negative effects on both sound quality and tone, the cross-section of the air channel (sound channel) of the rotor, the switcher channel, should be identical to the cross-section of the pipes used as valve slides and connectors to the tuning slides. Therefore, manufacturers aim to achieve a perfectly circular switcher channel with a very smooth interior.

However, perfectly circular switcher channels always result in an increase in valve dimensions, especially in those of the valve rotor. This in turn causes an unfortunate increase in the volume of materials used and in the overall weight of the valve block device. This contributes heavily to problems regarding the handling and maintenance of brasswind instruments. Moreover, it increases the manufacturing costs of such valves.

For these reasons, the switcher channels of most valves used in today's brasswind instruments are elliptical. In this case, a portion of the outer side of the valve rotor sound channel is omitted. To minimize negative effects on tone, influencing the sound quality, great efforts are made to keep the diameter of the switcher, and thus the overall dimensions of the valve, small. This approach is believed to minimize disturbing factors which have a negative impact on true sound reproduction. It is also hoped, with this approach, to achieve a better balance regarding overall sound quality and handling of the instrument.

Traditional brasswind instruments of today are actually the result of a compromise between reasonable price with easy handling and basic requirements regarding tone. However, for professionals striving to achieve the highest sound quality and perfect sound reproduction, the above mentioned problems have still not been resolved satisfactorily. State of the art technology does not permit high sound quality while keeping valves small and handy. Since it is still not possible to adhere to all requirements as mentioned above, we have decided to focus on achieving the best sound quality possible.

### DISCLOSURE OF THE INVENTION

Regarding the problems mentioned above, this invention avoids an increase in valve size and weight and therefore helps to prevent a decrease in instrument quality and handling. It also makes it possible to manufacture an optimal valve block device for metallic wind instruments, usually brasswind instruments, that helps to improve sound quality.

To solve the problem, a valve block device for music instruments according to the present invention comprises a casing part and a plurality of movable parts. The casing part contains a plurality of cylindrical inner holes, and has at least one pair of through holes in each side wall of the inner holes. The at least one pair of through holes are connected to the inner holes. Each of the movable parts is installed inside the cylindrical inner holes respectively and contains at least one channel so that such parts can connect at least one of the pairs of through holes with each other through its movement.

Since the valve block casing is made of resin, e.g. polyimide, it is possible to increase the dimensions of internal movable parts without adversely affecting the weight of the casing to any significant extent, an approach that is impossible with valve block casings made of metal. As parts of the valve interior are connected by internal channels, this design also allows for a higher degree of freedom regarding the shape of those sound channels and the manufacture of smooth, perfectly, circular sound channels. All this provides a foundation for the manufacture of a brasswind instrument with dramatically improved sound quality because of the lightweight valve block device featuring perfect sound channels.

In the following section, details of the origin and development of the invention will be discussed. In the past, as the name already indicates, brasswind instruments have been made almost entirely of metal. To musicians and instrument manufacturers who strive for high sound quality, it was obvious that changing the valve part containing the sound channel would have an impact on sound quality, most probably decreasing it, if resin were used. Until now it has seemed to be impossible to achieve any improvement in sound quality by using resin. It can be assumed that manufacturing a sound tube of resin not only reduces dramatically the sound quality of the instrument, but, by generating heterogeneous sounds, practically renders the instrument unusable. However, the inventors of this patent have found that a significant increase in sound quality can be achieved by manufacturing the frame construction of the switching mechanism of the sound tube, i.e. the valve block casing, using a particular type of resin, while avoiding any impact on the typical tone of the instrument. This is a somewhat unusual approach, which seems to be in contradiction to the assumptions of traditional musical instrument manufacturing.

Since the entire valve block casing is made of resin, no corrosion can take place and no corroded metal can build up in the interior of the valve block device. This makes for easy maintenance of the instrument and guarantees unhindered movement of the valves for long periods of usage. In contrast, when the valve block casing is made of metal, which is the case in all traditional brasswind instruments, maintenance and cleaning are not an easy task. Especially during cleaning, very small changes in shape and very small cracks on the surface of the metal can occur, which may later have a negative impact on the sound quality of the instrument. Additionally, in the case of a casing made of metal, there is the danger of corrosion occurring on the outer surface of movable parts and the inner surface of the casing. This may cause severe constraints on the degree of movement or, in the worst case, even a valve jam.

If brasswind instruments are equipped with a valve block casing made of resin, as recommended in our patent proposal, the above mentioned problems caused by corrosion cannot occur. The total functionality of the brasswind instrument can be maintained over a long period of time without any serious problems.

One desirable aspect of our valve block device for brasswind instruments is the use of at least one cover part which is installed on both or either ends of the cylindrical inner holes to cover all of the movable parts. With this design, it is relatively easy to separate the inner movable parts from the case to guarantee easy disassembly, which is helpful for maintenance and cleaning.

Another desirable aspect of our valve block device is that the valve block casing can be manufactured as a single integrated unit. This forms the base for housing several valves as integrated valve units within one casing. Difficulties encountered during the traditional assembly of valve units related to maintaining the exact shape and dimensions of individual valve units interconnected with short pipes, which in turn are fixed by means of tin solder, are entirely eliminated. Since the valve block device is installed in the instrument as a fully integrated unit, there is no need for the exceptional skill and experience required to determine the precise dimensions and positions of individual parts before the heat intensive soldering takes place, in order to produce a fully functioning assembly after all parts have cooled. Shape deformations of the valve block device caused over a long period of use are also entirely eliminated with this fully integrated valve block device. Recycling of the valve block device is possible because of the easy installation and dis-installation of the entire unit. Due to its fully integrated structure, resulting in high stability and easy installation, the usual customary adjustments of individual valve units and of the instrument itself after installation, are no longer required.

Another desirable aspect of the valve block device mentioned above is that the movable part is a valve rotor, which has a circular profile or cross section and rotates within the interior of the valve. The cover part contains axle bearings supporting the rotors. With such a design it is possible to improve the sound quality of brasswind instruments with rotary valves without increasing the weight of the valve block device.

When the movable part of the inner hole consists of a piston which changes its position along its own axis, it is also possible to improve the sound quality of the brasswind instrument. Here also the improvement is possible without increasing the weight of the valve block device.

The features of our invention as mentioned in the following are not only in regard to the newly introduced valve block device but also in regard to brasswind instruments that are equipped with such a valve block device.

In the case of brasswind instruments equipped with such a valve block device, the sound quality can be improved significantly by providing an ideal sound channel. Thanks to our invention, this can now be realized without the problem of increase in weight of the valve block device and consequently of the entire instrument.

### BRIEF DESCRIPTION OF THE DRAWINGS

FIG. 2 shows an outline of a brasswind instrument with a valve block device installed in the form of the first embodiment.

FIG. 2A shows an outline of the valve block device which can be installed in a brasswind instrument as shown, for example, in FIG. 1.

FIG. 2B shows a side view of the valve block device shown in FIG. 2A.

FIG. 3 shows a cross-section of the valve block device shown in FIG. 2A, section AA.

FIG. 4 shows a cross-section of the valve block device shown in FIG. 2B, section BB.

FIG. 5 shows a cross-section of an individual valve in enlarged view.

FIG. 6 shows a valve block device in the form of the second embodiment with a partially cut-away side wall.

### BEST MODE FOR CARRYING OUT THE INVENTION

### FIRST EMBODIMENT

FIG. 1 provides an overview of the spatial position of an installed valve block device in respect of a trumpet. In this figure the valve block device installed is in the form of the first embodiment. The trumpet shown consists of a mouthpiece 10, where the musician places his lips. Further components shown are the mouthpipe 20 leading straight away from the mouthpiece, the valve slides of different lengths 31, 32, 33, the integrated valve unit 40 as the valve block device of the instrument containing the switching mechanism for the sound channel, several bent pipes 51, 53 and straight pipes 52 which are interconnected, and the branch and tuning slide 50 that form together with a bell-shaped pipe (bell) 60 the end of the instrument. Turning levers 70 and the push mechanism 80 are also shown. Turning levers 70 are used to drive the valve unit 40 and the push mechanism 80 is used to transmit the movement of the turning levers 70 to the valve unit 40.

In this figure several valve slides 31, 32, 33 of different lengths are shown connected to the mouthpipe20. The pitch of a note can be varied by connecting different combinations of valve slides. This operation is carried out by the valve unit 40, a unit which supports easy disassembly and re-assembly.

The valve unit 40 shown contains three rotary valves, which will be described in detail later. A valve switches one sound channel that lies between the mouthpipe 20 and the tuning slide 50. This permits the selection of one of the valve slides 31, 32, 33 and thus controls the length of the pipe system through which the sound travels from the mouthpipe 20 to the tuning pipe 50.

The three levers 70 shown are used to control the valves. By means of these levers the musician can activate the turning mechanism 80 which operates the valve unit 40. This allows the musician to press different combinations of levers 70 causing in turn the switching of valve slides 31, 32, 33 accordingly. Thus the pitch of the sound emitted from the bell 60 is controlled.

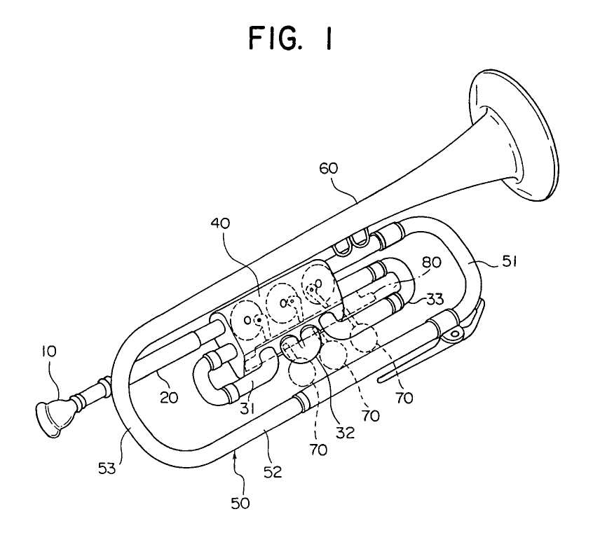

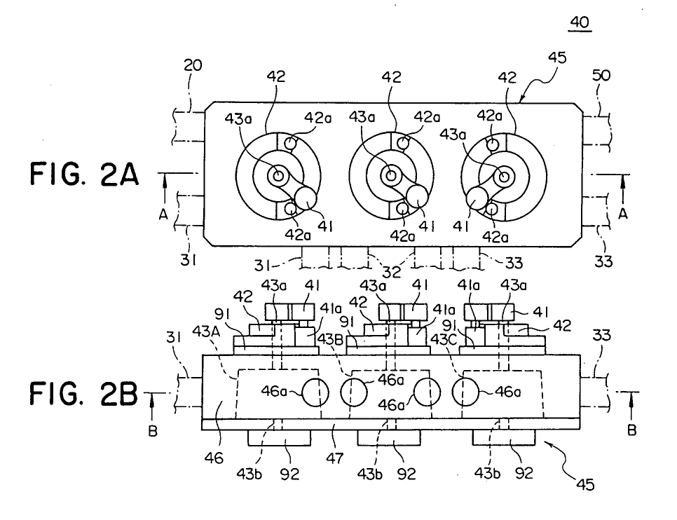

FIG. 2A shows an outline of the valve unit 40. FIG. 2B shows a side view of the valve unit 40. The valve unit 40 has a three rotary mechanisms 41 on its upper part, which are linked to the press mechanism 80 (as shown in FIG. 1) to rotate. The valve unit 40 also contains three stoppers 42, which determine the degree of rotation of the rotary mechanisms 41. The rotary mechanism 41, which is made of metal, e.g. brass, is fixed at the upper end of the valve axle 43a. By means of these three valve axles 43a, the three inner rotors 43A-43C in the casing 45 can be moved. Each individual stopper 42 of each valve is made of metal, e.g. new silver, and contains two stop limiters 42a, which are made of a soft material. The stop limiters 42a of the stopper 42 contact with the stops 41a formed under part of the rotary mechanisms 40 when the rotary mechanisms 41 reach the either ends of their moving range. That is, the stoppers 42 define the rotation ranges of the rotary mechanisms 41 or the inner rotors 43A-43C by means of contact of the stop limiters 42a with the stop 41a Through the levers 70 and the transmission mechanism 80 the rotors 43A-43C are controlled and can rotate within a range of 90°.

The valve block 45 consists of the valve block casing 46, which is made of resin, and a cover plate 47, which is made of a light metal, e.g. aluminium. The valve block casing 46 contains three cylindrical holes that contain the three rotors 43A-43C. The cover plate 47 is fixed to the rear part of the block casing 46 by members such as threads, so that the three rotors 43A-43C can be accommodated and supported in the three cylindrical holes. On the outer surface of the valve block casing there are several connections 46a where the valve slides 31, 32, 33 can be connected. Through these connections 46a a link to the interior of the valves can be established and by means of the rotors, sound channels can be switched. On the valve block casing 46, there are three axle bearing fixtures 91 which are fixed by threads together with the stoppers 42. In the cover plate 47 opposite them there are three more axle bearing fixtures 92 made of brass. These axle bearing fixtures 91, 92 are used to fix the axle bearings (not shown in the figure) of the valve axles 43a, 43b of the rotors 43A-43C.

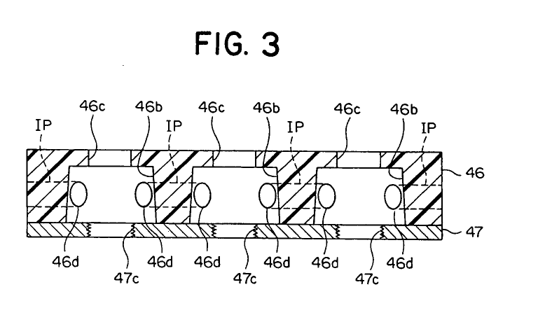

In FIG. 3, a cross-section of the valve block device, with rotors 43A-43C as in FIG. 2A, section AA, is shown in the position for disassembly. The valve block casing 46 contains three inner holes 46b, which contain the three rotors 43A-43C. These three holes 46b are of a slightly conical shape with the tip of the cone pointing to the top in the figure. At this point it should be mentioned that it is due to the slightly conical shape of the profile that the mechanical contact between the outer surface of the rotors 43A-43C and the inner surface of the holes can be adjusted. The incidence of the side walls of the inner slightly conical holes 46b is about 0.5/22 mm. Above (inner side of the bottom of the casing hole) the slightly conical holes 46b is a hole 46c, which is used to install the axle bearing fixture 91 as described above and shown in FIG. 2B. Opposite it in the cover plate 47 there is also a hole 47c for each valve, which is used for installing axle bearing fixtures 92. Also on the inner side walls of the slightly conical holes 46b there are circular holes 46d, which are used to connect these inner conical holes through the inner channels IP. Each pair of such circular holes 46d on the inner side walls can be connected to each other through the sound channels of the rotors 43A-43C.

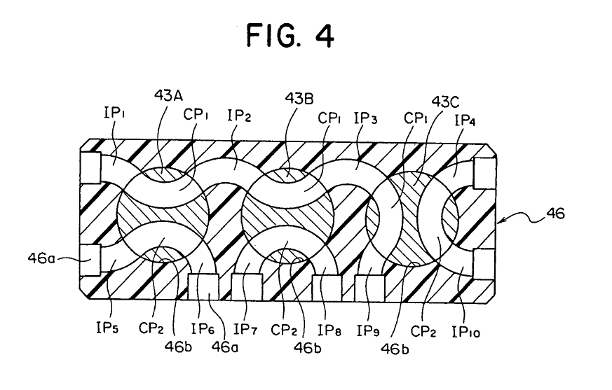

FIG. 4 shows a cross-section of FIG. 2B, section BB, to support the detailed description of the structure of the sound channels. Inside the valve rotors 43A-43C there is a pair of switching channels CP₁, CP₂ which have a circular profile with a smooth inner surface. Inside the valve block casing 46 there is an inner channel IP₁, which links the mouthpipe 20 shown in FIG. 1 to the hole 46b shown in FIG. 4 on the left side. There is another inner channel IP₂, which links the left side hole 46b to the hole 46b in the center. Yet another inner channel IP₃ links the hole 46b in the center to the hole 46b on the right side. The inner channel IP₄ links the hole 46b on the right side to the valve slide 33. Further inner channels IP₅, IP₆, of the valve block casing link the valve slide 31 (see FIG. 1) to the hole 46b on the left hand side as shown in FIG. 4. The inner channels IP₇ and IP₈ link the valve slide 32 to the hole 46b in the center. The inner channels IP₉ and IP₁₀ link the valve slide 33 to the hole 46b on the left side. All channels IP₁-IP₁₀ have a circular profile with a smooth inner surface.

The rotor 43A on the left side links directly the inner channel IP₁ to the inner channel IP₂ through the switching channel CP₁ as shown in the figure. By 90° counter-clockwise rotation, the rotor 43A on the left side links the inner channels IP₁ and IP₂ to the valve slide 31 (see FIG. 1) through the inner channels IP₅and IP₆ using CP₁ and CP₂. The rotor 43B in the center links directly the inner channels IP₂ and IP₃ through the switching channel CP₁ as shown in the figure. By 90° counter-clockwise rotation, the rotor 43B in the center links the inner channels IP₂ and IP₃ to the valve slide 32 (see FIG. 1) through the inner channels IP₇ and IP₈ using CP₁ and CP₂. The rotor 43C on the right side links the inner channels IP₃ and IP₄ to the valve slide 33 through IP₉and IP₁₀ using CP₂ and CP₂ as shown in the figure. By 90° clockwise rotation, the rotor 43C on the right side links the inner channels IP₃ and IP₄ directly to each other using CP₂. The design shown is arranged in such a way that, during switching of the rotors 43A-43C, all contact points establish a smooth link without any cracks or gaps in between the channels IP₁-IP₁₀ and the switching channels CP₁ and CP₂, a condition that guarantees an ideal connection for the travel of the sound.

The valve rotors 43A-43C are made of brass. First the body framework is manufactured using a mold. Next the inner wall of the switching channels CP₁ and CP₂ of the block manufactured first, is ground and polished, to obtain a smooth surface. Afterwards the outer contours of the rotor body are refined using milling machines and grinders to obtain a final shape with as high a degree of precision as desired.

The valve block casing 46 can be made of any one of a number of different resins, e.g. resins of the polyimide family. They guarantee very high mechanical resistance while being durable and resistant to deformity. Their weight is also relatively low. Aromatic resins of the polyimide family are best for our purpose. Another major desirable aspect of this resin is its high heat resistance of up to 400° C. This is very important in the process of dissolving the inner mold of the valve block casing using heat treatment. To manufacture the valve block casing 46, first the inner (lost) mold defining the contour of the valve holes 46b and the inner channels IP₁-IP₁₀ needs to be modeled. This mold has to be made of a metal or other material that melts at a temperature which is lower than the melting temperature of resins of the polyimide family. In the next step, the inner mold is fixed to the outer mold, which defines the actual shape of the valve block casing46. Then, the empty space between the two molds is filled with polyimide resin using an extrusion molding process. Next, material hardening processes are applied stepwise. Afterwards, the outer mold is removed and the part together with the inner mold is heated until the inner (lost) mold melts.

After removal of the inner mold, the valve block casing 46 can be retrieved in its desired shape as shown in FIGS. 3 and 4. With the method outlined above the valve block casing 46 can be manufactured as a fully integrated unit containing inner channels IP₁-IP₁₀, which have smooth, perfectly circular profiles.

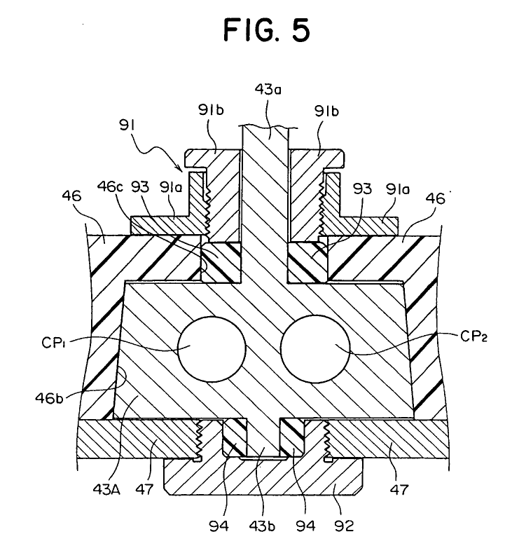

FIG. 5 shows an enlarged view of the cross-section of a valve. At the end of the lower and upper side of the rotor 43A there is a pair of axles 43a, 43b. The upper axle 43a contains an additional circular bearing 93 made of resin. This bearing is installed in the upper hole of the valve hole 46c, to stabilize rotation. Its direction of movement is guided by the bearing fixture 91. The lower axle 43b is fixed by the bearing 94, which is also made of resin. The circular bearing 94 is enclosed by the bearing fixture 92, which in turn is fixed on the outer wall of the cover plate 47. The bearing fixture 91 consists of a circular outer part 91a that is fixed on the valve block casing and a circular inner part 91b that is fixed on the inner side of the outer part 91a. This determines the position of the circular bearing 93 along the axis. Through precise adjustment of the circular inner part 91b the vertical position of the circular bearing fixture 93 along the rotation axis can be determined, thus achieving an optimal rotational movement. In a similar fashion the position of the circular bearing 94 can be determined by precisely adjusting the bearing fixture 92. This allows a musician to adjust the position of a rotor 43A along its rotation axis, which provides control of the gap between the outer surface of the rotor 43A and the inner wall side of the valve 46b, a feature that allows for adjusting the mechanical contact resistance according to individual requirements. If any extraneous matter enter the valve and prevent the rotor 43A from rotating freely, loosening bearing fixture 92 will remedy the problem.

The following passage deals with the handling of the instrument and describes the mechanism of the movable parts of a trumpet, as shown in FIGS. 1 to 5. When the musician depresses all levers 70 of the trumpet, all rotors 43A-43C turn until they reach their stoppers. By depressing various combinations of these levers, the musician can switch the valve slides 31, 32, 33 and control the pitch of the sound that is emitted through the bell 60. To clean the valve unit 40, it is necessary first to remove the movement mechanism 41 and the bearing fixture 92 together with the cover plate 47 of the valve block casing 46. Then the valve rotors 43A-43C can be removed from the valve block casing 46 and the interior of the valve unit 40 can be cleaned. Since the valve block casing 46 is made of resin, the dimensions of the rotors can be increased without causing a significant increase in weight of the valve unit 40. This allows the inner switching channels CP₁ and CP₂ of the rotors 43A-43C to have a perfect channel profile, i.e. an exactly circular profile and a smooth inner surface. This perfect sound channel provides the opportunity for dramatically improved sound quality, even though the weight of the valve unit 40 itself, and the overall weight of the instrument remain almost unchanged.

In the embodiment of the valve block casing 46 described above, the valve unit 40 with its resin casing was installed in a trumpet. However, such a valve unit 40 can be also installed in a horn or in another brasswind instrument. In this case the valve unit 40 needs to be modified for the instrument regarding the number of valves, rotors and valve slides.

In the embodiment of the valve block device described above polyimide is used to manufacture the valve block casing 46. Other resins, such as epoxy compounds, can be used too, but they need to be extremely strong epoxy resins, with a heat resistance of more than 180° C. This type of epoxy is generally used for mold making and tool making in the iron and steel industry. The material of the inner lost mold should be then a metal with low melting temperature.

In the embodiment described above, the material used to manufacture the rotors 43A-43C is brass. However, an alternative material for manufacturing could be used, as long as it is not subject to corrosion due to the influence of saliva. Even resin could be used for the manufacturing of the rotors. However, in this case a detailed investigation of all the relationships between the rotors 43A-43C and the case 46 regarding adhesion, friction, etc. needs to be carried out, in order to determine which type of resin would be appropriate.

In the embodiment described above the case 46 of the valve unit 40 is designed as a fully integrated unit, but it would also be possible to manufacture a valve unit 40 that consists of several individual rotary valves, each equipped with a case made of resin. However, in this case, the components need to be interconnected among by metal pipes.

### SECOND EMBODIMENT

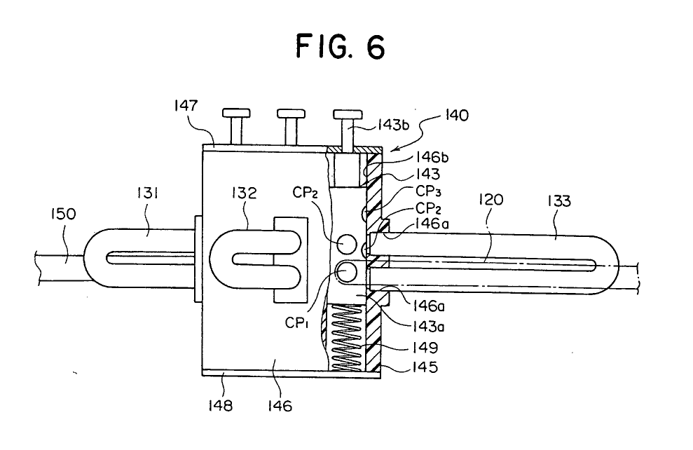

FIG. 6 shows a section of the design for the main part of a trumpet mechanism using the second embodiment. In this case the trumpet is a piston valve trumpet. It consists of a mouthpipe 120, which is connected to the mouthpiece (not shown in the figure), three valve slides 131, 132, 133 of different lengths, a valve unit 140 that switches the sound channels, and a pipe 150 that is connected to the bell (not shown in the figure).

The valve unit 140 shown consists of the case 145 and pistons 143 made of brass, which are enclosed in cylindrical holes 146b within the interior of the case 145, with valve buttons 170, which are fixed to the tops of the pistons 143.

The case 146 made of resin contains additional case covers 147 and 148, which are fixed on the upper and lower side of the case 146. On the side wall of the case 146 there is a circular hole 146a to connect the valve slides, e.g. valve slide 131. The hole 146a is linked to the inner hole 146b.

The piston 143 itself consists of a cylindrical main part 143a and a shaft 143b, which extends through the hole in the cover plate 147, thus protruding from the case 145 as shown in the side view of the partially cut-away casing in the figure. On the upper side of the shaft 143b, there is a valve button fixed. The lower part of hole 143b which is located beneath the cylindrical part 143a contains a spiral spring 149. When the musician depresses the valve button 170, the piston 143 moves downwards. When the finger is removed from the valve button 170, the piston 143 returns back to its original position due to the pressure exerted by the spring. With the piston 143 in its original upper position, the switching channel CP₁ is linked to the pipe part 120. With the piston 143 in its lower position, the switching channel CP₂ is linked to the pipe part 120. Additionally with this position of the piston 143 the switching channels CP₁ and CP₂ are linked to the valve slide 133, and the pipe part 120 and valve slide 133 are linked to each other through CP₂. The valve slide 133 is also linked to the center part of the piston valve through switching channel CP₃.

The description above relates only to the piston valve shown. However, in the case of the other piston valves used, switching of the sound channels to control the pitch of the sound using the valve slides 131, 132, 133, can be achieved in a similar fashion.

In the second embodiment described above, the piston 143 has a cylindrical shape. However, since the cylindrical hole 146b is located in the case 146, which is made of resin and therefore can be manufactured to any shape, the piston 143 itself can also be of any shape. For example, the piston 143 profile could be triangular and the hole 146b could be manufactured accordingly.

The second embodiment of the valve unit 140 using a piston valve has been described in the context of installation in a trumpet. However, this second embodiment of the valve unit 140 which contains a casing made of resin of the polyimide family can also be installed in a horn, e.g. a Vienna horn with piston valves.

1. A valve block device for music instruments, comprising:
a casing part that is entirely made of resin, contains a plurality of cylindrical inner holes, and has at least one pair of through holes in each side wall of the inner holes, the at least one pair of through holes being connected to the inner holes;
a plurality of movable parts, each containing at least one channel, such parts being installed inside the cylindrical inner holes and capable of connecting through movement at least one of the pairs of through holes with each other; and
at least one cover part being removably installed on at least one end of the cylindrical inner holes to cover all of the movable parts,
wherein the casing part is formed integrally by molding.

2-3. (canceled)

4. A valve block device for music instruments according to claim 1, wherein the movable parts are the turning rotors, which rotate in the inner circular holes having circular profiles, and the at least one case cover part contains axle bearings supporting the rotors.

5. A valve block device for music instruments according to claim 1, wherein the movable parts are pistons which are located in the cylindrical holes and can displace the position along the direction of axis thereof.

6. A brasswind instrument, comprising a valve block device for music instruments, wherein the valve block device comprises:
a casing part that is entirely made of resin, contains a plurality of cylindrical inner holes, and has at least one pair of through holes in each side wall of the inner holes, the at least one pair of through holes being connected to the inner holes;
a plurality of movable parts, each containing at least one channel, such parts being installed inside the cylindrical inner holes and capable of connecting through movement at least one of the pairs of through holes with each other; and
at least one cover part being removably installed on at least one end of the cylindrical inner holes to cover all of the movable parts,
wherein the casing part is formed integrally by molding.

7. A valve block device for music instruments according to claim 1, wherein the casing part is made of either polyimide or a similar resin.

8. A valve block for music instruments according to claim 1, wherein the moveable parts are made of metal.

9. A brasswind instrument according to claim 6, wherein the movable parts are the turning rotors, which rotate in the inner circular holes having circular profiles, and the at least one case cover part contains axle bearings supporting the rotors

10. A brasswind instrument according to claim 6, wherein the movable parts are pistons which are located in the cylindrical holes and can displace the position along the direction of axis thereof.
